(19) United States
(12) Patent Application Publication
(10) Pub. No.: US 2011/0034158 A1
(43) Pub. Date: Feb. 10, 2011

(54) MOBILE USER ACTIVITY INFORMATION MANAGEMENT SYSTEMS AND METHODS

(75) Inventors: Kevin Taylor Bradley, Washougal, WA (US); Gerald Wayne Hines, Olympia, WA (US)

Correspondence Address: MARGER JOHNSON & MCCOLLOM, P.C., 210 SW MORRISON STREET, SUITE 400, PORTLAND, OR, 97204, US

(73) Assignee: ICOOPER, INC., Washougal, WA (US)

(21) Appl. No.: 12/537,199

(22) Filed: Aug. 6, 2009

(51) Int. Cl. H04M 3/00; H04M 1/00

(52) U.S. Cl. 455/418; 455/550.1

(57) ABSTRACT

A machine-controlled method can include a mobile electronic device presenting to a mobile user a graphical user interface (GUI) that allows the mobile user to enter mobile user activity information corresponding to a particular mobile user activity, receiving the mobile user activity information from the mobile user through the GUI, creating a correlation between the mobile user activity information and the particular mobile user activity, and transmitting to a remote database system the mobile user activity information and the correlation between the mobile user activity information and the particular mobile user activity.

### TECHNICAL FIELD

The disclosed technology pertains to capturing mobile data, and more particularly to mobile user activity information management mechanisms implemented in connection with mobile devices.

### BACKGROUND

Mobile devices such as cellular/wireless telephones, which are generally referred to as mobile phones, and handheld computing devices such as personal digital assistants (PDAs) have become increasingly popular over the past decade. Many of today's mobile devices have a built-in wireless capability to connect to the Internet and personal or work-related computer systems. Among the wide variety of other features that are generally available with modern mobile devices are the ability to watch streaming video (or download and store videos for later viewing), built-in cameras and/or video recorders, a memory card reader, an interface port such as a USB port, infrared and/or Bluetooth capabilities, WiFi connectivity, and instant messaging.

The continued advances in the technical capabilities of today's mobile devices fuels an ever-growing number of software applications that are specifically geared toward mobile device users. Such consumer applications can include virtually everything from mobile news services to personal organizers to mobile coupons and discount offers to informational guides on local activities and events to tools for creating and managing mobile device-specific websites. Despite the number of mobile device applications that have been developed over the years, there remains a need for effective information management systems directed toward user activity tracking.

### SUMMARY

Embodiments of the disclosed technology can include a mobile user activity information management system composed of a mobile device application component and a remote data management system that will be referred to herein as a database-in-the-sky (DBITS). Using the mobile device application component, a mobile user can create or update an account with the system. Once the mobile user has an active account with the system, the mobile user can create, edit, and/or delete mobile user activities that pertain to the mobile user.

The system can provide the mobile user with a number of mobile user activity-specific features. For example, the system can enable the mobile user to add an attachment or add a contact to virtually any given mobile user activity. The system can also enable the mobile user to add a point of interest such as a geographic location that has a connection to the mobile user activity. For example, the mobile user can add a starting point or a final destination for the mobile user activity. The mobile user can also add or edit data fields and templates that pertain to the mobile user activity.

In certain embodiments, the system can perform synchronization functions to ensure that the mobile user's activity-specific information stored on his or her mobile device is consistent with the corresponding data that is stored by the DBITS. Should the system encounter any inconsistencies in the data, the system can alert the mobile user to such inconsistencies and provide the mobile user with a mechanism for resolving such data conflicts.

### BRIEF DESCRIPTION OF THE DRAWINGS

FIG. 1 is a block diagram illustrating an example of a mobile user activity information management system for mobile devices.

FIG. 2 is a block diagram illustrating an example of a mobile device that can be used in connection with implementations of the disclosed technology.

FIG. 3 is a flowchart illustrating a first example of a machine-controlled method of managing mobile user activity information.

FIG. 4 is an example of a mobile user activity information management system launch screen.

FIG. 5 is an example of a mobile user activity information management system mobile user login screen.

FIG. 6 is an example of a mobile user activity information management system mobile user login success notification screen.

FIG. 7 is an example of a mobile user activity information management system mobile user registration screen.

FIG. 8 is an example of a mobile user activity information management system home utility directory screen.

FIG. 9 is a flowchart illustrating a second example of a machine-controlled method of managing mobile user activity information.

FIG. 10 is a first example of a mobile user activity information management system home activity directory screen.

FIG. 11 is a second example of a mobile user activity information management system home activity directory screen.

FIG. 12 is a flowchart illustrating a third example of a machine-controlled method of managing mobile user activity information.

FIG. 13 is an example of a mobile user activity information management system add activity screen.

FIG. 14 is a flowchart illustrating a fourth example of a machine-controlled method of managing mobile user activity information.

FIG. 15 is an example of a mobile user activity information management system activity schedule screen.

FIG. 16 is an example of a mobile user activity information management system add attachment screen.

FIG. 17 is an example of a mobile user activity information management system data field edit screen.

FIG. 18 is an example of a mobile user activity information management system add template screen.

FIG. 19 is an example of a screenshot of a first mobile user activity record.

FIG. 20 is an example of a screenshot of a second mobile user activity record.

FIG. 21 is an example of a screenshot illustrating a Done selector within an activity completion sub-screen.

FIG. 22 is an example of a mobile user activity information management system activity history screen.

FIG. 23 is a first example of a mobile user activity information management system synchronization resolution screen.

FIG. 24 is a second example of a mobile user activity information management system synchronization resolution screen.

FIG. 25 is an example of a mobile user activity information management system alert screen.

FIG. 26 is an example of a mobile user activity information management system support information screen.

### DETAILED DESCRIPTION

Embodiments of the disclosed technology pertain to the management of mobile user activity information. As used herein, mobile user activity information refers to information pertaining to one or more activities that a mobile user performs in connection with a particular job, where a mobile user generally refers to a user that uses one or more mobile devices to capture the mobile user activity information. Thus, as used herein, mobile user activity information can include information that a mobile user wants or needs to have captured, stored, and/or tracked.

Certain embodiments can include a combination of a data management service and a mobile application intended for use on handheld computing devices such as mobile phones. The mobile application can provide a subscribed registrant with various tools to manage his or her mobile user activity information. The mobile user activity information can be stored remotely in a web-accessible database system that can be be monitored, accessed, and/or manipulated via the mobile application or via a web portal. As used herein, the database system will be referred to as a database-in-the-sky (DBITS).

Mobile users can enter mobile user activity information as free form data that the mobile application can capture and transmit to the DBITS. The system is capable of handling many different types of field data. In certain embodiments, the system can capture field data and associate it with a particular activity before transmitting the data to the database in the sky. The mobile user can track the progress of his or her mobile user activities via the mobile application. The system can capture any changes the mobile user may make to existing activities and synchronize the mobile device with the DBITS such that corresponding mobile user activity records are consistent with each other.

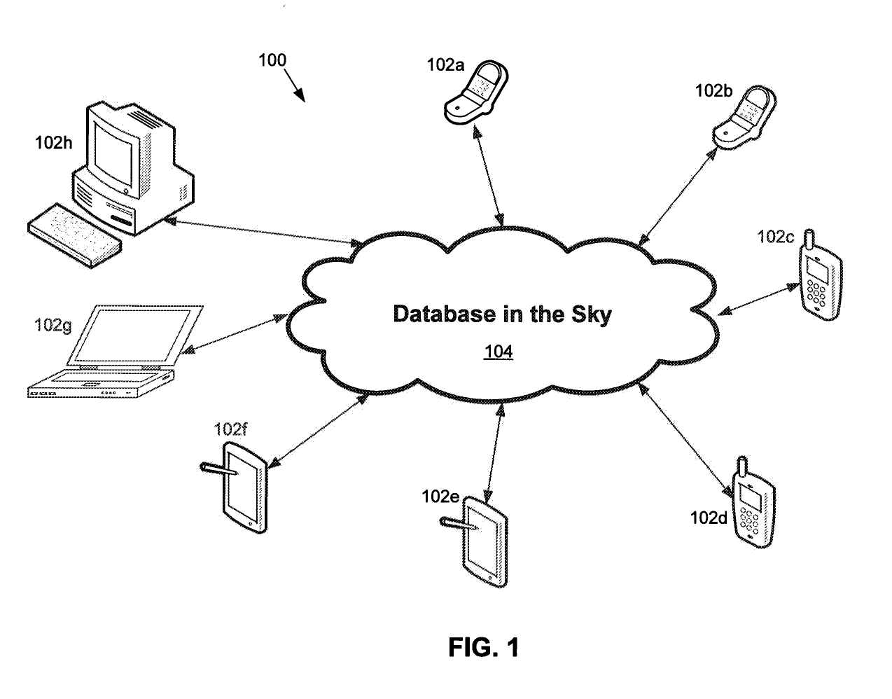

FIG. 1 is a block diagram illustrating an example of a mobile user activity information management system 100 for mobile devices such as mobile phones. In the example, a number of mobile devices 102a-102g are each in communication with a database-in-the-sky (“DBITS”) 104. Each of the mobile devices 102a-102g can be used by a corresponding mobile user to add, edit, and/or delete mobile user activity information stored by the DBITS 104. In certain embodiments, synchronization operations can ensure that the mobile user activity information stored by any of the mobile devices 102a-102g is consistent with corresponding mobile user activity information stored by the DBITS 104. For example, any of the mobile devices 102a-102g can update a group record or individual records that share mobile user activity information. In the example, a backend system 102h is also in communication with the DBITS 104. The backend system 102h can be used for input and reporting purposes in connection with the mobile user activity information, for example.

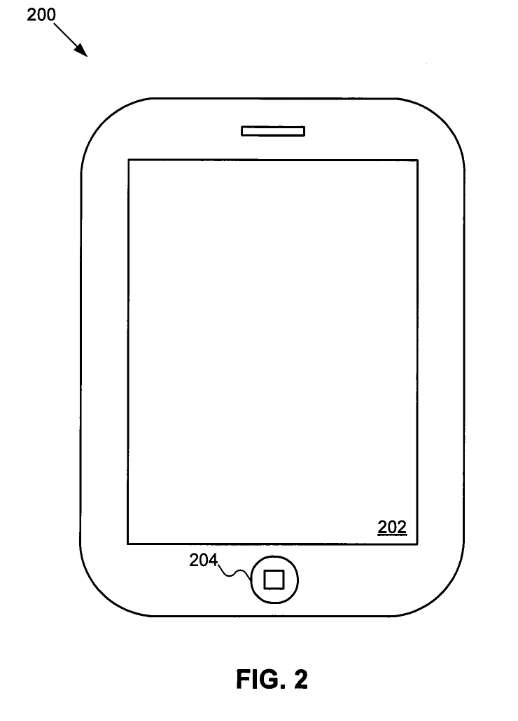

FIG. 2 is a block diagram illustrating an example of a mobile device 200 that can be used in connection with implementations of the disclosed technology. In the example, the mobile device 200 includes a display screen 202 and a button 204. As used herein the display screen 202 can include a traditional screen, a touch screen, or some other type of screen, and can be used to facilitate a graphical user interface (GUI). The mobile device 200 can also include a physical interface (not shown), such as a USB port, that can be used to enable hard-wired communications between the mobile device 200 and a computing device (not shown) such as a personal computer. In certain embodiments, the mobile device 200 can be a mobile phone such as an Apple iphone. iPhone™ is a trademark of Apple, Inc.

### Mobile User Activity Information Management System Launch Screen

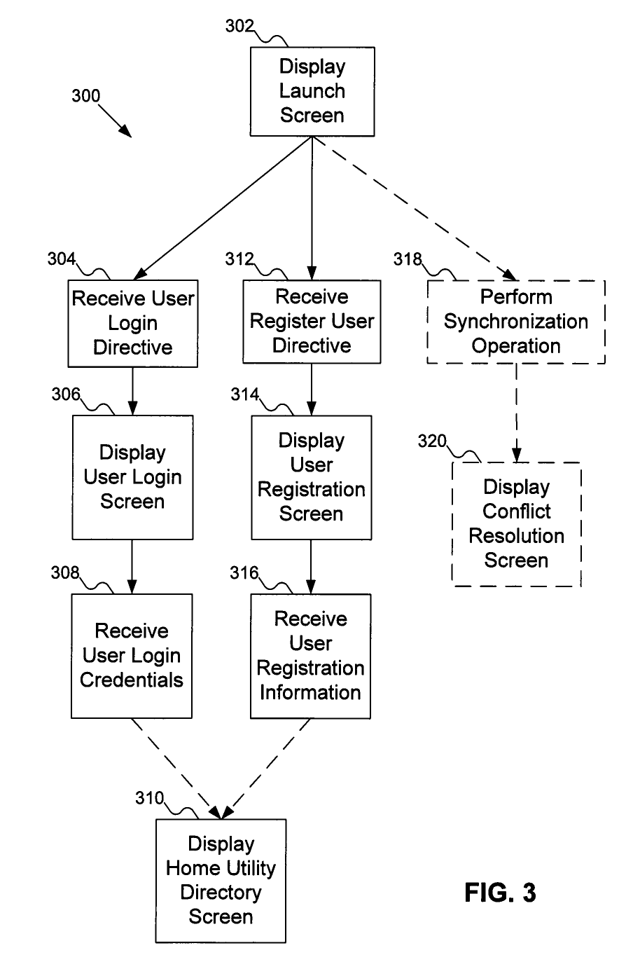

FIG. 3 is a flowchart illustrating a first example of a machine-controlled method 300 of managing mobile user activity information in connection with implementations of the disclosed technology. At block 302, the mobile user activity information management system displays on a mobile user's mobile device a launch screen that can enable the mobile user to access a mobile user login screen or a mobile user registration screen.

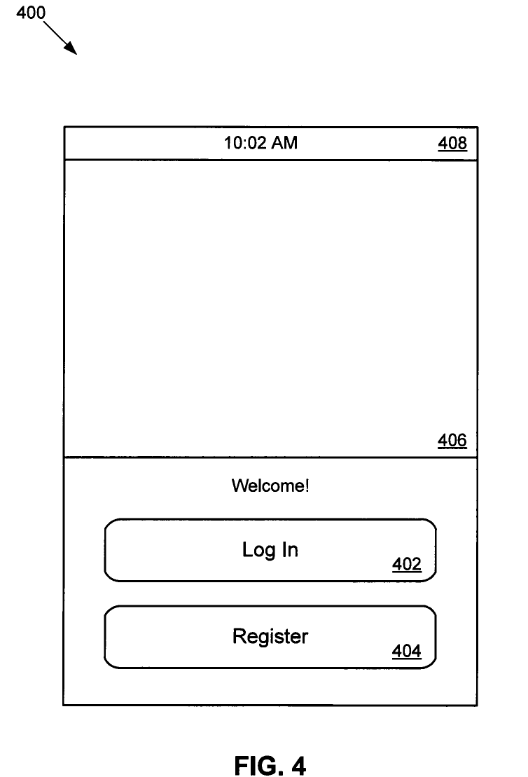

FIG. 4 illustrates an example of a mobile user activity information management system launch screen 400. In the example, the launch screen 400 includes a Log In button 402, a Register button 404, an initial display area 406, and an information header area 408. The initial display area 406 can be used to display brand information, login information, and/or other types of information. The information header area 408 can be used to display time/date information, signal strength, carrier information, and battery charge information.

### Mobile User Activity Information Management System User Login Screen

At block 304 of FIG. 3, the system receives a login directive from a mobile user. For example, the mobile user may have previously created an account with the system and now wishes to log in to the system to enter some new mobile user activity information or to edit some existing mobile user activity information. The mobile user can communicate the login directive to the system by pressing the Log In button 402 displayed within the launch screen 400 on the mobile device.

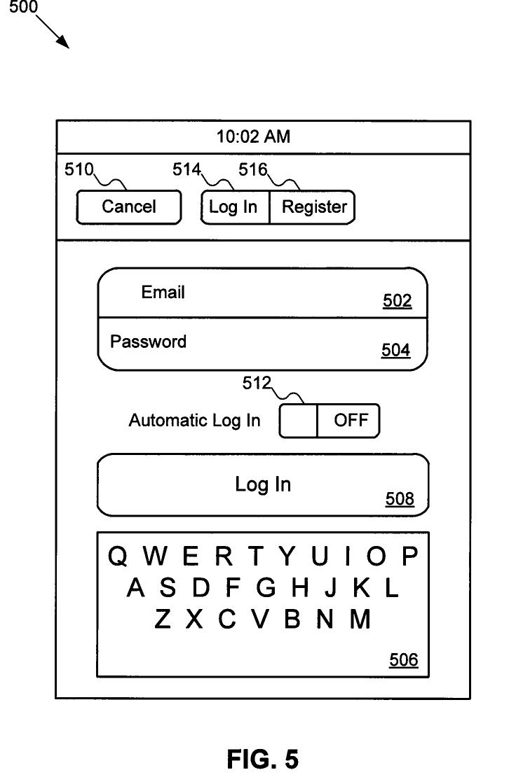

Responsive to receiving the user login directive, the system can then display on the mobile device a mobile user activity information management system user login screen, as shown at block 306. FIG. 5 illustrates an example of a mobile user login screen 500. In certain embodiments, the system can request as login information an email address and a password. Thus, the system can enable the mobile user to enter his or her email address 502 and password 504 within the mobile user login screen 500 on the mobile device.

The system can provide the mobile user with a virtual keyboard 506 or some other information entry mechanism to enter the login information, as shown at block 308. One having ordinary skill in the art will recognize that the virtual keyboard 506 illustrated in FIG. 5 is provided as an example only and that other virtual keyboards can be used, such as keyboards that include some or all of the following keys: “up arrow,” “delete/backspace,” “.?123,” SPACE, “@,”“.,” and NEXT.

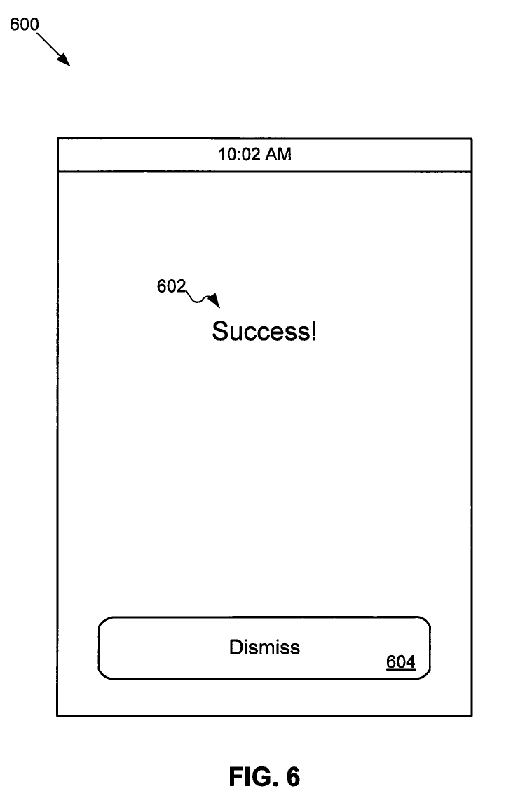

Once the mobile user has entered his or her login information, he or she can press the Log In button 508 displayed within the user login screen 500 on the mobile device. Upon a successful login attempt, the system can display a mobile user activity information management system user login success notification screen 600 as illustrated in FIG. 6, for example. Upon closing of the login success notification screen 600 by the system or the mobile user, the system can then display on the mobile device the home utility directory screen, as shown at block 310.

Should the mobile user wish the exit the user login screen at any point before completing the user login process, the mobile user can simply press a Cancel button 510 displayed within the user login screen 500 and the system can return the mobile device display to the launch screen, for example.

In situations where the mobile user has previously created an account with the system but cannot remember the credentials he or she used, the system can provide an option such as a Forgot Password button (not shown) that initiates a query of the user for certain information such as an answer to a security question. Responsive to a correct answer to the security question, the system can then send an email message containing the mobile user's password to the email address associated with the user's account. In certain embodiments, the system can send to the account holder an email having a link that enables the user to log into a website for the purpose of resetting the mobile user's password based on a cored response to a security question, for example.

In certain embodiments, the system can provide an Automatic Log In feature that the mobile user can turn on or off by toggling an Automatic Log In button 512 displayed within the user login screen 500 on the mobile device. If the mobile user turns the feature on, for example, the system can automatically log the mobile user into the system by remembering the mobile user's credentials and applying the mobile user's credentials for each subsequent mobile user activity information management session.

In the example, a second Log In button 514 and a Register button 516 can be used to enable the mobile user to switch between mobile user login and mobile user registration screens. For example, if the mobile user proceeds to the mobile user login screen 500 and then realizes that he or she has not yet registered with the system, the mobile user can press the Register button 516 and the system can then display a mobile user registration screen, which is discussed in detail below.

### Mobile User Activity Information Management System User Registration Screen

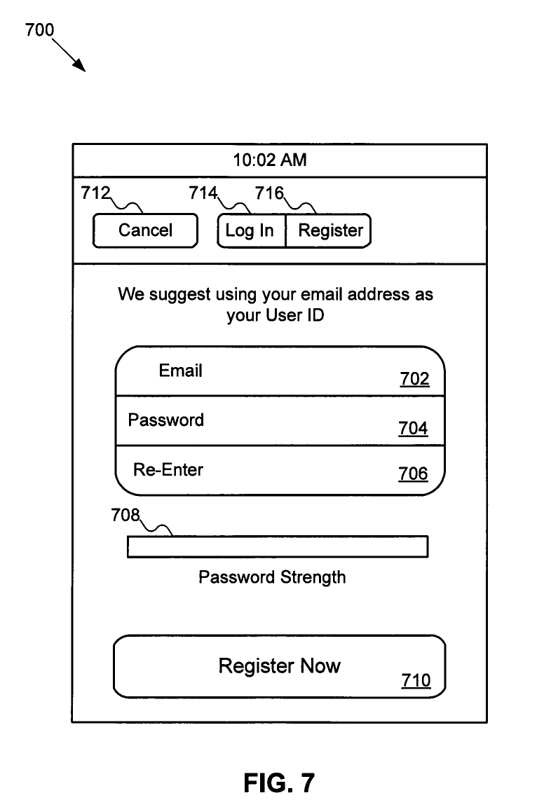

At block 312 of FIG. 3, the system receives a register user directive from a mobile user. For example, the mobile user can press the Register button 404 displayed on the mobile device within the launch screen 400 of FIG. 4. Responsive to receiving the register mobile user directive, the system can then display a mobile user activity information management system user registration screen, as shown at block 314. FIG. 7 illustrates an example of a mobile user registration screen 700.

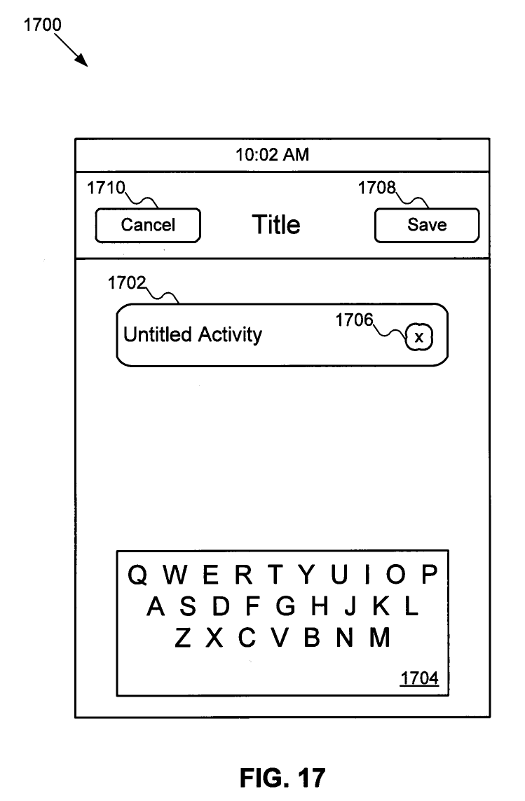

The system can require a mobile user to enter certain credentials in order to use the mobile user activity information management system. In the example, the system can request that the mobile user enter an email address 702 and a password 704 as his or her credentials. The system can also request that the mobile user confirm his or her password selection by re-entering his or her password 706. The system can present the requested information as line items displayed on the screen. In order to enter the requested data for each line item, the mobile user can press the corresponding line item on the screen. The system can then present a data field edit screen, such as that illustrated in FIG. 17, which is discussed below. The mobile user can thus provide the requested information by using the data field edit screen.

A password strength indicator can be used to provide the mobile user with a relative measure of the complexity and associated effectiveness of the password as currently entered by the mobile user. In the example, the system presents to the mobile user the relative strength of the user-selected password via an indicator bar 708. In certain embodiments, the credentials entered by the mobile user can be synchronized and verified with an active dataset of registrants who have subscribed and are authorized to use the system.

Once the mobile user has entered the requested credentials, the mobile user can press a Register Now button 710 displayed on the mobile device. In the example, block 316 shows the mobile device receiving the credentials from the mobile user. The mobile device can then transmit the credentials to the database-in-the-sky (DBITS) component of the system, which can create an account specifically for the mobile user. The DBITS component can also create a unique device identification number (UDID) and associate the UDID with the user's mobile device. In certain embodiments, the UDID is always static on the mobile device and can be placed in code to enable the mobile user's profile. The system can use the UDID to provide the mobile user with the ability to install the mobile device application on the user's mobile device.

If the mobile user registration is successful, the system can display on the mobile device a screen confirming the receipt and successful registration of the mobile user's credentials. The successful registration screen can be similar to the login success notification screen 600 illustrated in FIG. 6. Upon successful completion of the mobile user's registration, the system can then make the mobile application component of the system completely available to the mobile user. In the example, the system can display on the mobile device the home utility directory screen, as shown at block 310.

In certain embodiments, the system can send an email to the newly-registered mobile user requiring him or her to authenticate the selected login credentials. Such authentication be used in order to enable the mobile user to use certain back end functionalities of the system, such as reporting.

In the illustrated example, the system can provide the mobile user with a Log In button 714 and a Register button 716 to enable the mobile user to switch between mobile user login and mobile user registration screens at any point before completion of the registration process. For example, if the mobile user proceeds to the mobile user registration screen 700 and then realizes that he or she has already created an account with the system, the user can press the Log In button 714 and the system can then display a mobile user login screen, such as the mobile user login screen 500 illustrated in FIG. 5 and discussed in detail above.

### Mobile User Activity Information Management System Home Utility Directory Screen

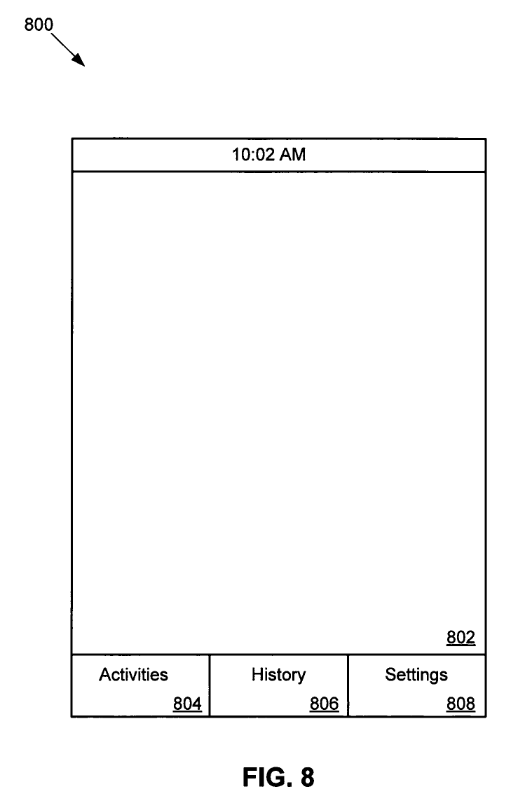

Once the mobile user has logged in or successfully completed the mobile user registration process, the system can display on the mobile device a mobile user activity information management system home utility directory screen 800 as illustrated in FIG. 8, for example. The home utility directory screen 800 can have a display sub-area 802 that can be used to display brand information or other types of information. The home utility directory screen 800 can also include an Activities button 804, an activity History button 806, and a Settings button 808. Any or all of these buttons 804-808 can include an icon or some other type of identifier (not shown).

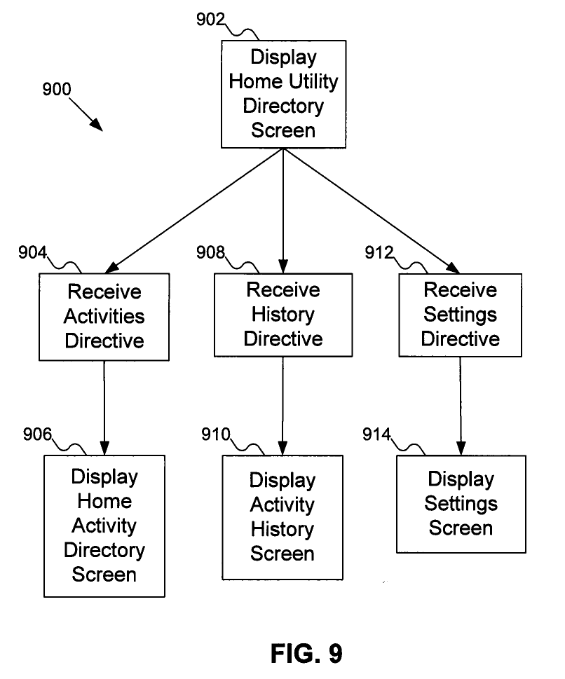

FIG. 9 is a flowchart illustrating a second example of a machine-controlled method 900 of managing mobile user activity information in connection with implementations of the disclosed technology. At block 902, the mobile user activity information management system displays on the mobile device a home utility directory screen such as the home utility directory screen 800 illustrated in FIG. 8.

### Mobile User Activity Information Management System Home Activity Directory Screen

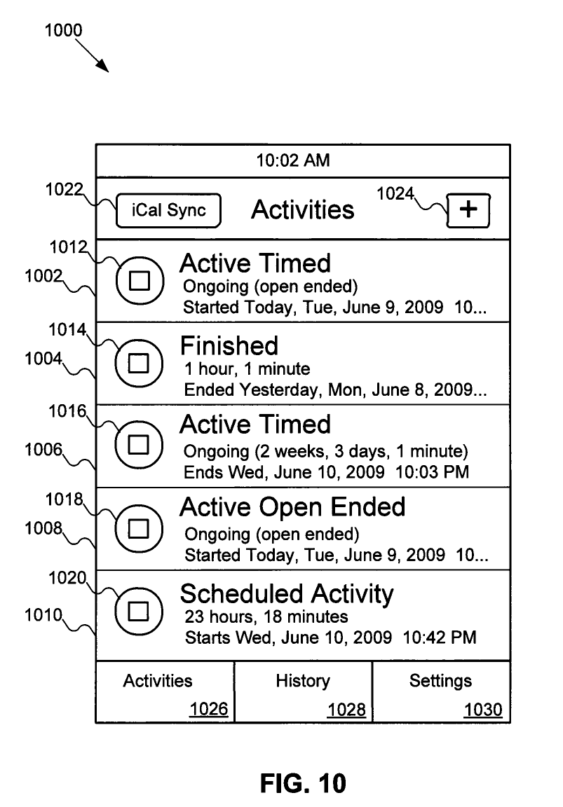

At block 904 of FIG. 9, the system receives an Activities directive from a mobile user. The mobile user can communicate the Activities directive to the system, for example, by pressing the Activities button 804 displayed within the home utility directory screen 800. Responsive to receiving the Activities directive, the system can then display a home activity directory screen, as shown at block 906. FIG. 10 illustrates a first example of a home activity directory screen 1000 as displayed on a user's mobile device.

The home activity directory screen 1000 can display a directory of the mobile user's activities and provide mechanisms that the mobile user can use to view and manage his or her displayed activities. Thus, the mobile user is able to quickly see pertinent information and current statuses of some or all of his or her active activities at once. In certain embodiments, the home activity directory screen 1000 can display the mobile user's ongoing activities with jewel effects to denote the current state of each activity, the title and remaining duration of each activity, and the number of attachments associated with each activity. Certain displayed items such as the jewel effects can be refreshed or updated, for example, either in real-time or after a synchronization function has been performed.

As used herein, mobile user activity records generally refer to sets of data fields that are associated together for a specific unified purpose such as storing information pertaining to a particular mobile user activity. Mobile user activity records can be reviewed and edited by the user or other authorized personnel via the user's mobile device or via a web-based interface, for example.

In the example, the home activity directory screen 1000 lists as line items five separate activities 1002-1010. The activities 1002-1010 are displayed with corresponding jewels 1012-1020, respectively, which are discussed below. An iCal Sync button 1022 and an Add Activity button 1024 are also displayed within the home activity directory screen 1000 on the mobile device and are discussed below.

In certain embodiments, the system can display each stored activity as a line item in a scrollable list, where each line item contains the title information, the start and/or end times for the mobile user activity, and the number of attachments associated with the mobile user activity. The line items can be listed in order of status and/or chronology. By touching a particular activity line item displayed within the home activity directory screen 1000, the system can take the mobile user to the activity view screen for the selected mobile user activity.

In certain embodiments, the activity view screen is the activity edit screen, which is also referred to herein as the add activity screen and is discussed below. In certain alternative embodiments, however, the activity view screen may be different than the add activity screen and may thus be handled differently by the system and/or the mobile device user. For example, the system can prevent the mobile user from making any changes to a mobile user activity directly within the activity view screen but provide the mobile user with an Edit button displayed within the activity view screen that, when pressed by the mobile user, can prompt the system to display the activity edit screen for the activity.

The home activity directory screen 1000 can also display an activity History button 1028 and a Settings button 1030 to enable the user to toggle between different displays. For example, responsive to the mobile user pressing the History button 1028, the system can display on the mobile device an activity history screen. A button corresponding to the presently-displayed screen can be disabled. In the example, the Activities button 1026 is disabled (e.g., darkened) because the corresponding screen, the home activity directory screen 1000, is the screen that is currently being displayed.

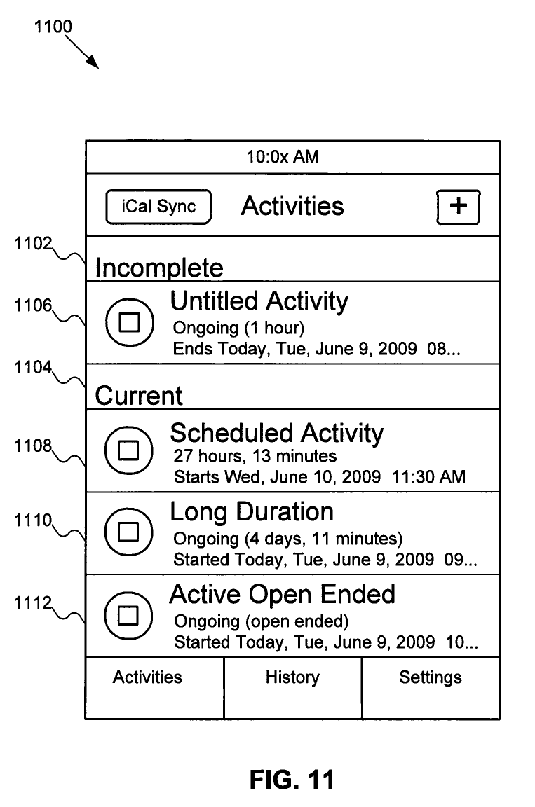

In certain embodiments, the mobile user can view his or her upcoming or outstanding mobile user activities in a number of different ways. For example, the mobile user can specify whether the mobile user activities are to appear as line items on the screen in chronological sequence or in the order that they were entered. FIG. 11 is an example of a home activity directory screen 1100 in which an incomplete activity 1106 is presented under an Incomplete header section 1102 and current activities 1108-1112 are grouped together under a Current header section 1104.

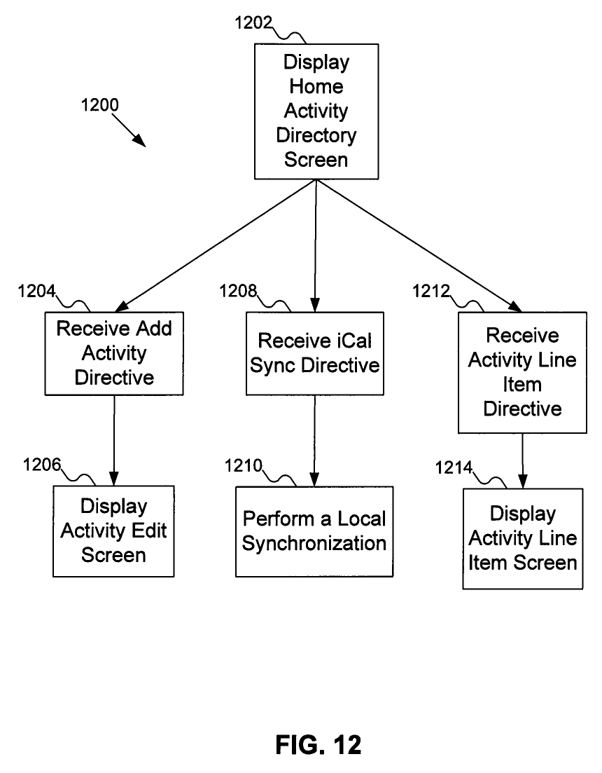

FIG. 12 is a flowchart illustrating a third example of a machine-controlled method 1200 of managing mobile user activity information in connection with implementations of the disclosed technology. At block 1202, the system displays a home activity directory screen, such as the home activity directory screen 1000 of FIG. 10.

### Adding an Activity via Add Activity

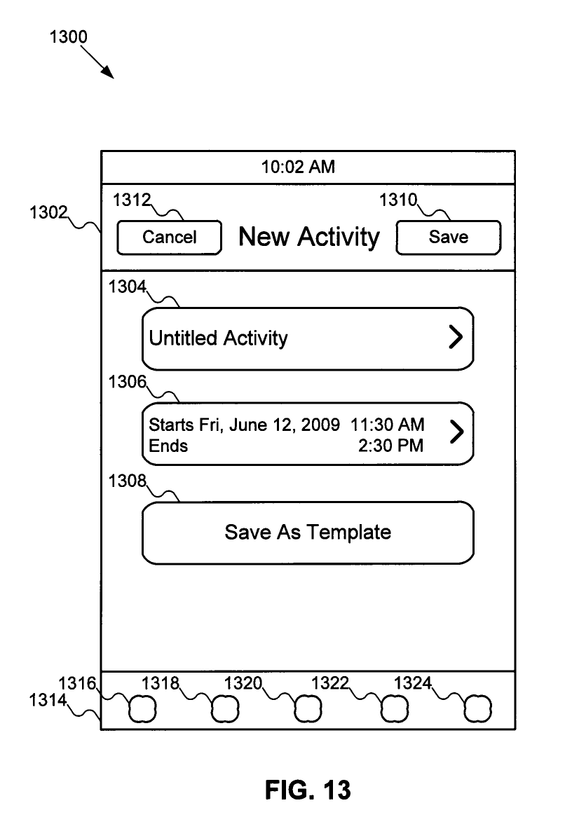

At block 1204 of FIG. 12, the system receives an add activity directive from a user. The mobile user can communicate the add activity directive to the system, for example, by pressing the Add Activity button 1024 displayed within the home activity directory screen 1000 on the mobile device. Responsive to receiving the add activity directive, the system can then display on the mobile device a mobile user activity information management system activity edit screen, as shown at block 1206. FIG. 13 is an example of an add activity screen 1300.

The add activity screen 1300 can enable a mobile user to create new activities and/or edit previously created activities. In the illustrated example, an upper banner section 1302 includes two buttons: a Cancel button 1312 and a Save button 1310. The Cancel button 1312 can enable a mobile user to exit the activity edit screen 1300 without creating a new activity or saving any changes to an existing activity. The Save button 1310 can be used to record any information entered regarding the activity within the system. For example, such changes can be stored in both a mobile device application component of the system and a DBITS component.

In certain embodiments, the add activity screen 1300 can display the label and data for each data field associated with the activity as items in a scrollable list. The mobile user can update the information in each of the data fields by indicating the line item on the touch-screen of the mobile device, which will take the mobile user to the data field edit screen, which is discussed below. In certain embodiments, a mobile user can delete one or more data fields from the particular mobile user activity. For example, the mobile user can slide his or her finger across the line item that he or she wishes to remove from the mobile user activity. Responsive to the mobile user action, the system can then delete the identified data field from the activity.

A toolbar portion 1314 of the add activity screen 1300 can include multiple buttons 1316-1324 that can be used to associate various data and characteristics to a given activity. These buttons 1316-1324 can include Add Attachment, Add Contact, Add Point of Interest, Add Data Fields, and Add Template buttons, respectively, each of which are discussed below. In certain embodiments, the buttons 1316-1324 can be distinguished from each other by way of different icons displayed therein. For example, a paper clip, a person's head, a sight with crosshairs, a number of lines, and a number of overlapped rectangles can be displayed on buttons corresponding to Add Attachment, Add Contact, Add Point of Interest, Add Data Fields, and Add Template functions, respectively.

In the example, the add activity screen 1300 also includes a Save As Template button 1308 that can enable the mobile user to save a template with the data fields as defined on the current mobile user activity being added or edited by the mobile user. The saved template can then be stored on the mobile device and thus be readily available for quick retrieval on subsequent activities.

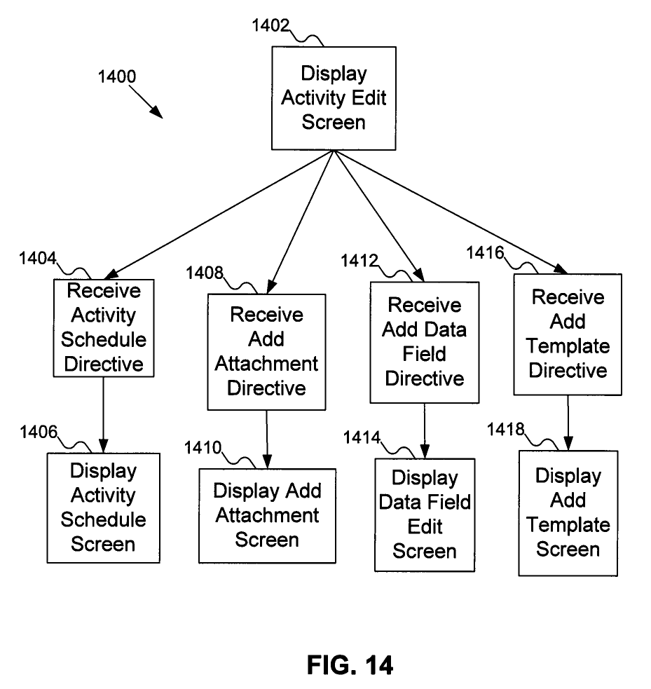

FIG. 14 is a flowchart illustrating a fourth example of a machine-controlled method 1400 of managing mobile user activity information in connection with implementations of the disclosed technology. At block 1402, the system displays an activity edit screen, such as the activity edit screen 1300 of FIG. 13.

### Mobile User Activity Information Management System Activity Schedule Screen

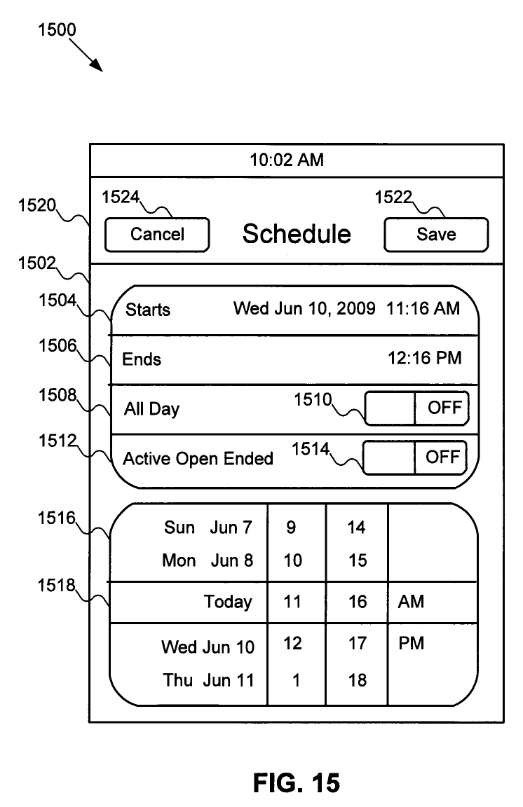

At block 1404 of FIG. 14, the system receives an activity schedule directive from a user. The mobile user can communicate the activity schedule directive to the system, for example, by pressing the Activity Schedule button 1306 displayed within the activity edit screen 1300 on the mobile device. Responsive to receiving the activity schedule directive, the system can then display on the mobile device a mobile user activity information management system activity schedule screen, as shown at block 1406. FIG. 15 is an example of an activity schedule screen 1500.

Each mobile user activity has an associated active timeframe that is defined by a start time and an end time. The activity schedule screen 1500 can provide the mobile user with the ability to select a start and an end time for a given activity using the touch screen functionality of the mobile device. In the example, a schedule details section 1502 of the activity schedule screen 1500 provides the user with a “Starts” field 1504 and an “Ends” field 1506 to enter the mobile user activity's start time and end time, respectively. In certain embodiments, the “Starts” field 1504 can be displayed in a manner that contrasts with the “Ends” field 1506. For example, the “Starts” field 1504 can be displayed in a darker color or other contrasting manner.

In the example, the schedule details section 1502 of the activity schedule screen 1500 includes a calendaring module 1516 that has a rolodex-type effect. The mobile user can “spin” each of several virtual cylinders that contain information pertaining to date, hour, minute, and AM/PM. In the example, the mobile user has selected Jun. 9, 2009, at 11:16 AM, as indicated at 1518.

The schedule details section 1502 of the activity schedule screen 1500 also provides the user with two line items 1508 and 1512 that include toggle switches 1510 and 1514, respectively. The first line item 1508 can enable the mobile user to identify the mobile user activity as an all day event and the second line item 15012 can enable the mobile user to identify the mobile user activity as an open event. Other line items (not shown) can also be displayed to provide the user with even further schedule-related features for the corresponding activity.

A header section 1520 of the activity schedule screen 1500 displayed on the mobile device can include a Save button 1522 and a Cancel button 1524. The mobile user can press the Save button 1522 to save his or her changes, and the Cancel button 1524 can be used by the mobile user to leave the activity schedule screen 1500 without saving any changes to the activity that the mobile user may have entered before pressing the Cancel button 1524.

### Mobile User Activity Information Management System Add Attachment Screen

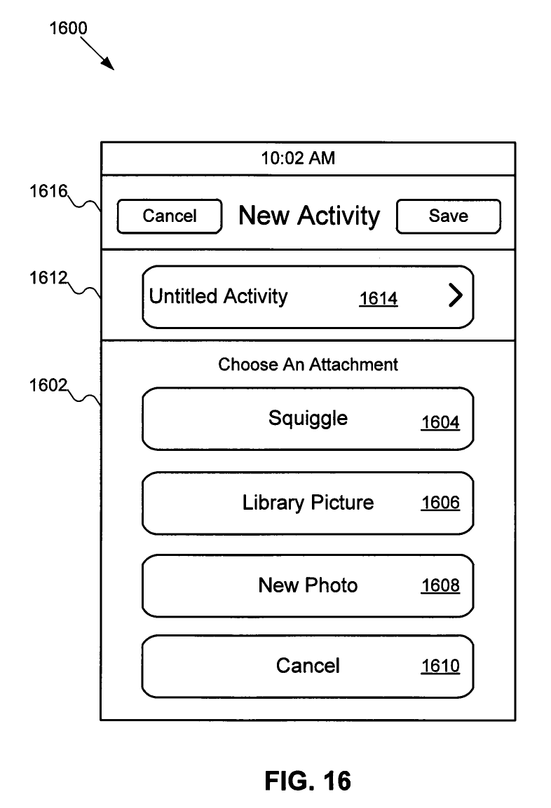

At block 1408 of FIG. 14, the system receives an add attachment directive from a mobile user. The user can communicate the add attachment directive to the system, for example, by pressing the Add Attachment button 1316 displayed within the toolbar portion 1314 of the activity edit screen 1300 on the mobile device. Responsive to receiving the add attachment directive, the system can then display on the mobile device a mobile user activity information management system add attachment screen, as shown at block 1410. FIG. 16 is an example of an add attachment screen 1600.

In the example, the add attachment screen 1600 has an attachment section 1602, an activity identification section 1612, and a header section 1616. The activity identification section 1612 can provide information 1614 identifying the mobile user activity to which the mobile user may add one or more attachments. The header section 1616 can include Cancel and Save buttons. In certain embodiments, the activity identification section 1612 and/or the header section 1616 can be grayed out until the user has finished selecting attachments, for example.

Any of a number of different items can be attached to a mobile user activity such as a digital signature, image files, audio files, documents, emailed pdf files, etc. Once selected, the attached files can be transmitted from the mobile device to the DBITS component for future reference. The attachments can also become an enclosure or an exhibit for the mobile user activity as a whole.

In the example, the attachment section 1602 of the add attachment screen 1600 includes a Squggle button 1604, a Library Picture button 1606, a New Photo button 1608, and a Cancel button 1610, which can be presented in a manner that contrasts with the other buttons 1604-1608 displayed within the attachment section 1602. As used herein, a squiggle refers to a digital signature or a line drawing generated using the touch-screen feature or some other input from the mobile device, a library picture refers to an image that can be taken from the memory of the mobile device, and a photo refers to an image file that can be generated using a camera feature of the mobile device, for example.

Responsive to the user pressing the Squiggle button 1604, the system can create a new file and enable the mobile user to use his or her finger or stylus on a touch sensitive input of the mobile device to create the squiggle to be stored within the new file. An attachment pop-up screen (not shown) can provide the mobile user with the ability to review the newly-created file and determine its acceptability before saving the file. The squiggle file can then be saved as an image file in connection with the activity.

Responsive to the user pressing the Library Picture button 1606, the system can enable the mobile user to select an image from the memory of the mobile device. The mobile user can then select one or more images to be attached to the activity. Once selected, the system can store the images in connection with the particular mobile user activity. In certain embodiments, the image can be stored as a data field within the activity, separate from the resident photo library of the mobile device.

Responsive to the user pressing the New Photo button 1608, the system can enable the mobile user to create a new image using the camera functionality of the mobile device, for example. The system can also allow the mobile user to review the image for acceptability before associating the image with the particular mobile user activity. In certain embodiments, the image can be stored as a data field within the mobile user activity.

In certain embodiments, a mobile user can add one or more Notes to an existing attachment. Such a Note can include freeform text that the mobile user enters to describes the associated attachment. The system can format the Notes to facilitate features such as sorting and/or searching capabilities in connection with the Notes. In certain embodiments, a mobile user can add one or more Points of Interest to a particular data field of a given mobile user activity.

Once the mobile user has successfully indicated his or her preferences concerning the attachment(s) to be added to the mobile user activity, the system can return the mobile user to the activity edit screen. Additionally, the mobile device can synchronize the activity with the DBITS component to ensure that the activity-specific information stored within the mobile device is consistent with that stored within the DBITS component.

### Mobile User Activity Information Management System Add Contact Feature

In certain embodiments, the system can receive an add contact directive from a mobile user. The mobile user can communicate the add contact directive to the system, for example, by pressing the Add Contact button 1318 displayed within the toolbar portion 1314 of the activity edit screen 1300. Responsive to receiving the add contact directive, the system can then provide the mobile user with a directory containing links to one or more address books resident on the user's mobile device, for example. The mobile user can select one or more contacts from a line item list of contacts taken from the resident address book and displayed on the mobile device. The list can include names, phone numbers, and other relevant data stored within an address book resident on the mobile device, for example.

As used herein, a contact refers to information that identifies a person or entity and that can be added to a given activity, thereby making the contact a part of the activity going forward. In other words, the mobile user activity can retain the added contact for future reference. A contact can be added directly to the mobile user's address book within the user's mobile device, for example.

Once the mobile user has selected the relevant contact information, the system can store the contact as a data field within the mobile user activity record and return the mobile device to the activity edit screen. In certain embodiments, the contact information can be stored independent of the address book record within the DBITS component. After storing the contact as a data field in the particluar mobile user activity record, the system can advantageously provide the mobile user with the ability to place a phone call the contact directly from the mobile device without needing to exit the mobile application component of the system.

### Mobile User Activity Information Management System Add Point of Interest Feature

In certain embodiments, the system can receive an add point of interest directive from a mobile user. The mobile user can communicate the add point of interest directive to the system, for example, by pressing the Add Point of Interest button 1320 displayed within the toolbar portion 1314 of the activity edit screen 1300. Responsive to receiving the add point of interest directive, the system can then provide the user with the ability to associate a geographic location to a particular activity.

In certain embodiments, the system can allow the mobile user to enter the geographic location using GPS or other similar navigational technologies within the mobile device. When prompting the mobile user to associate a geographic location with an activity, the mobile application component can determine the degree of accuracy of the geographic location within a specified range, for example. The mobile user can then accept the location or request a greater degree of accuracy from the system before selecting the location. The system can store the geographic location in a lattitude/longitude format. The system can also create a link using a “pin drop” icon, for example, to provide the mobile user with easy reference to the geographic location on a map application.

Once the mobile user has selected a geographic location, the system can then automatically assign a name or enable the user to assign a name for the geographic location using a data field edit screen, for example. An example of a data field edit screen is illustrated in FIG. 17 and discussed in detail below.

### Mobile User Activity Information Management System Data Field Edit Screen

At block 1412 of FIG. 14, the system receives an add data field directive from a mobile user. The mobile user can communicate the add data field directive to the system, for example, by pressing the Add Data Field button 1322 displayed within the toolbar portion 1314 of the activity edit screen 1300. Responsive to receiving the add attachment directive, the system can then display a mobile user activity information management system data field edit screen, as shown at block 1414. FIG. 17 is an example of a data field edit screen 1700.

There are several predefined types of data field inherent within the mobile application component of the system that can be made available for use with any given activity. The predefined types of data fields include, but are not limited to, text, number, timestamp, currency, project, and percentage. By adding a project data field to an activity, for example, the mobile user is able to give the activity a project name. By doing so, the user is thus enabling the system to group together the mobile user's activities that have the same or similar project names for reporting-related functions, for example. Other data fields can pertain to costs or expenses associated with a given activity and can store such data either as a total amount or as different fields for each item.

Whereas the predefined data field types have typically been pre-formatted with pre-defined labels for the mobile user, the system can also provide the mobile user with the ability to create a custom data field and label the custom data field with a keyword giving it a data field format type. For example, if previously-defined data fields do not meet the user's requirements, he or she can create custom data fields that give a unique name to the predefined data variables to display data and values relevant to the activity being edited.

The add data field functionality can allow the user to insert a single additional data field or multiple additional data fields into the particular activity. The mobile user can initially choose from a list of predefined and labeled data fields. If the user chooses to insert multiple fields simultaneously, the data fields can be associated with the activity with no specific data attached, and the system can return the mobile device to the activity edit screen. If the user wishes to add a single data field, he or she can edit the data within the data field using the data field edit screen 1700.

In the example, the data field edit screen 1700 includes a data field identifier 1702 that identifies the particular data field to be edited. The data field edit screen 1700 also includes a touch-screen virtual QWERTY keyboard 1704 that can be used by the mobile user to enter data into the displayed data field. A data field exit button 1706 can be used by the mobile user to exit the presently-displayed data field and select a different data field to be edited using the data field edit screen 1700.

Once the data in the particular data field has been entered to the mobile user's satisfaction, the mobile user can press a Save button 1708. Responsive to the user pressing the Save button 1708, the system can then store the information at the mobile application and send the information to the DBITS component. Should the mobile user desire to exit the data field edit screen 1700 without saving any changes that the mobile user presently provided to the data field edit screen 1700, however, the mobile user can press a Cancel button 1706, which can return the mobile device to the previous screen, for example.

The mobile user can thus add, label, and define custom data fields using the data field edit screen 1700. Once created, a custom data field can be saved to the mobile device for future use. The custom data field functionality can be advantageously used by the user on the fly while creating an activity for which the data field is being created, for example. In certain embodiments, a methodology of user-defined dynamically captured data can be employed. For example, the methodology can include, at the time and location of mobile user data generation (regardless of whether the mobile user is using a mobile network or a more traditional in-house network), populating a database with predefined, formatted, and segmented data, and then forming relationships between individual pieces of the data for purposes such as referencing, integrating, and reporting.

In certain embodiments, the data fields can be stored in a segmented format such that the mobile user can define the structure of the data that forms the relationships within the data base. For example, each mobile user activity can form a relationship between the data fields within that mobile user activity record. Each field of data within that mobile user activity record can have attachments related to that particular data field. A mobile user activity record can be assigned a parent activity as part of the process of building a relationship tree in the database.

### Mobile User Activity Information Management System Add Template Screen

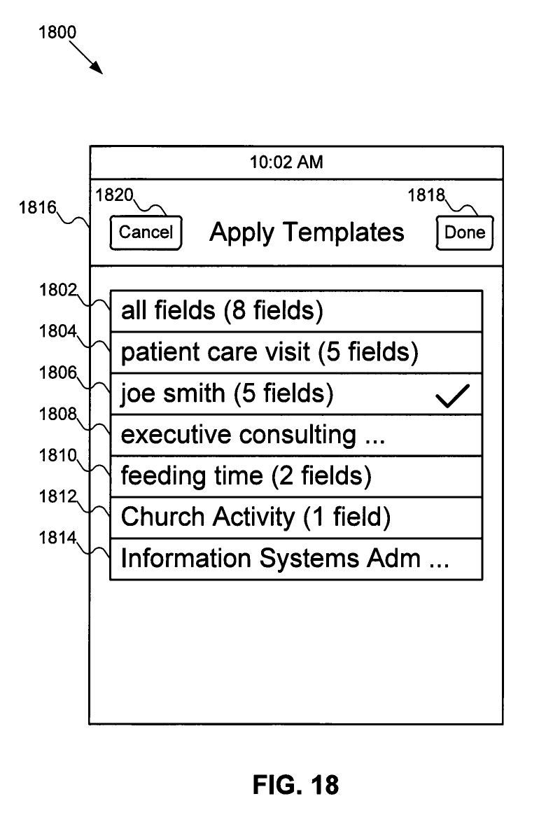

At block 1416 of FIG. 14, the system receives an add template directive from a mobile user. The mobile user can communicate the add template directive to the system, for example, by pressing the Add Template button 1324 displayed within the toolbar portion 1314 of the activity edit screen 1300. Responsive to receiving the add template directive, the system can then display a mobile user activity information management system add template screen, as shown at block 1418. FIG. 18 is an example of an add template screen 1800.

Responsive to the mobile user pressing the Add Template button 1324, the system can retrieve a list of templates that the user can use to quickly and easily apply a certain set of predefined data fields to the mobile user activity record being edited. As used herein, a template generally refers to a set or group of data fields. The mobile user can select any of the previously saved templates to quickly add a relevant set of data fields to the current activity. Once the template has been selected, the data fields can be added to the activity with or without any prepopulated data. In certain embodiments, the system can then return the mobile device to the activity edit screen.

In the example, the add template screen 1800 displays seven previously created templates 1802-1814. The templates can list the number of data fields associated with the template. For example, templates 1802, 1804, and 1806 have eight data fields, five data fields, and five data fields, respectively. An icon or other indicator can be used to identify one or more selected templates. In the example, a check mark indicates that the user has selected the third template 1806. The absence of check marks within the other listed templates 1802, 1804, and 1808-1814 indicates that the user has selected the third template 1806 only.

A header section 1816 of the add template screen 1800 can include a Done button 1818 and a Cancel button 1820. Once the mobile user has finished selecting one or more templates to be used, for example, the mobile user can press a Done button 1818. Responsive to the mobile user pressing the Done button 1818, the system can store the selected templates in connection with the particular activity both at the mobile device and at the DBITS component. Should the mobile user press the Cancel button 1820, however, the system can close the add template screen 1800 without saving any currently-entered information.

### Performing a Local Synchronization

In certain embodiments, the system can receive an iCal Sync directive from a mobile user, as shown at block 1208 of FIG. 12. The mobile user can communicate the iCal Sync directive to the system, for example, by pressing the iCal Sync button 1022 displayed within the home activity directory screen 1000. Responsive to receiving the iCal Sync directive, the system can perform a local synchronization operation, as shown at block 1210 of FIG. 12. For example, the system can prompt a synchronization of the mobile user activity information stored on the mobile device with corresponding data stored on the mobile user's personal computer, such as a desktop computer that is able to communicate with the user's mobile device.

### Mobile User Activity Activity Records

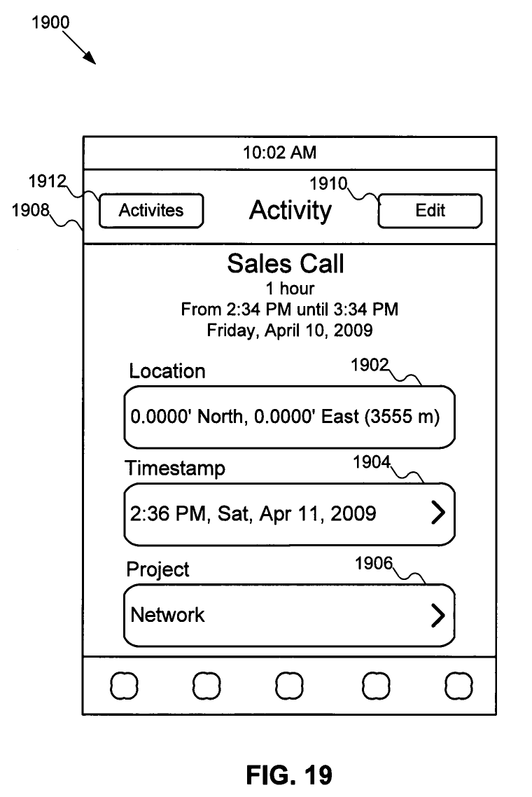

FIG. 19 is an example of a screenshot 1900 of a first mobile user activity record. In the example, a Location data field 1902 indicates a geographic location that has been pinned to the displayed mobile user activity. A Timestamp data field 1904 can provide information pertaining to when the displayed mobile user activity was created. A Project data field 1906 can indicate a project type such as Network, for example.

A header section 1908 of the screenshot 1900 includes an Edit button 1910 and an Activities button 1912. In the example, the mobile user can press the Edit button 1910 to edit the displayed activity. Responsive to the user pressing the Edit button 1910, the system can display the activity edit screen. Alternatively, the mobile user can press the Activities button 1912 to prompt the system to display the home activity directory screen, for example. In certain embodiments, the Activities button 1912 can have a different size and/or shape than other displayed buttons such as the Edit button 1910.

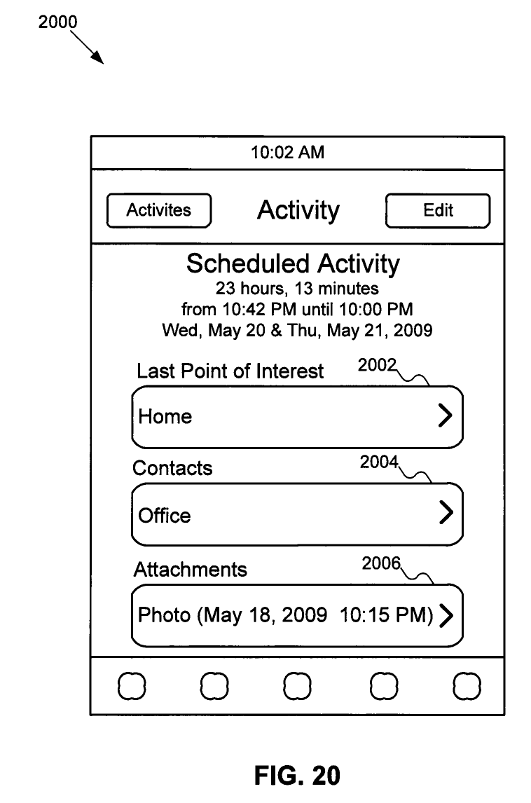

FIG. 20 is an example of a screenshot 2000 of a second mobile user activity record. In the example, a Last Point of Interest data field 2002 indicates a particular location, a Contacts data field 2004 indicates a particular contact associated with the displayed activity, and an Attachments field 2006 displays information that identifies a file that has been attached to the activity. In the example, a photo file has been attached to the activity.

### Mobile User Activity Activity Completion

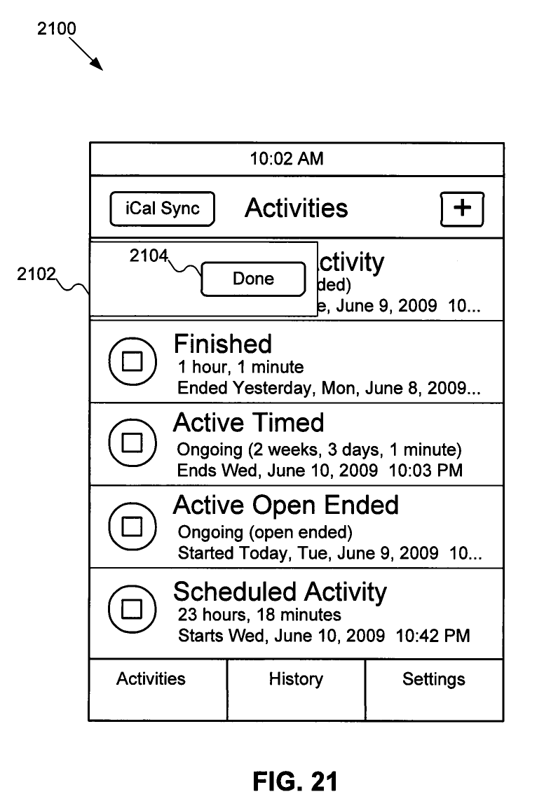

FIG. 21 is an example of a screenshot 2100 illustrating a Done selector within an activity completion sub-screen 2102. In the example, an activity completion sub-screen 2102 can be displayed as an overlay applied to the displayed activity. The system can display the activity completion sub-screen 2102 responsive to an activity completion indication from the mobile user. For example, the mobile user can press a jewel or icon displayed in connection with the activity to indicate that the mobile user activity has been completed.

In certain embodiments, the activity completion sub-screen 2102 can “slide” to right from the left-most edge of the screen 2100. The activity completion sub-screen 2102 can be displayed in a transparent manner such that the activity over which the activity completion sub-screen 2102 is applied is still at least partially viewable. Alternatively, the activity completion sub-screen 2102 can be displayed in an opaque manner.

In the example, the activity completion sub-screen 2102 includes a Done button 2104. The Done button 2104 can be displayed until the mobile user presses it or until a certain amount of time has passed. Responsive to the mobile user pressing the Done button 2104 or the amount of time being passed, the system can close the activity completion sub-screen 2102 and remove the completed activity from the list of displayed activities. If the current view is set to display completed activities, however, the completed activity can be displayed with other completed activities under a Completed header, for example.

### Mobile User Activity Information Management System Activity History Screen

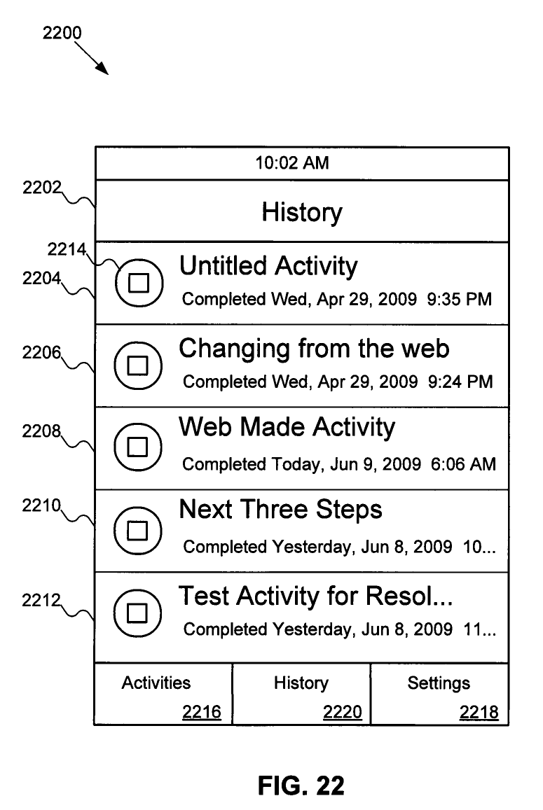

FIG. 22 is an example of a mobile user activity information management system activity history screen 2200. In certain embodiments, the system can enable the mobile user to perform a search of activities that have concluded or ended. The activity history screen 2200 can be used to display the mobile user's past activities and indicate that they were done. A section header 2202 can visually confirm that the current view is the activity history screen 2200.

In the example, the activity history screen 2200 includes five completed activities 2204-2212. Each displayed activity can have associated therewith a jewel or other icon signifying the activity's complete. For example, the first displayed activity 2204 has a jewel 2214 that can display a green check mark to indicate the completion status of the activity 2204.

The activity history screen 2200 can advantageously allow the mobile user to view his or her completed mobile user activities and also to make templates from the completed activities, if desired.

In certain embodiments, the system will not allow a completed mobile user activity to be removed from the activity history screen 2200 unless the user re-opens the mobile user activity and alters the stop time of the mobile user activity to be relevant within the current time frame.

The activity history screen 2200 also includes an Activities button 2216 and a Settings button 2218 that can provide the user with an efficient way to switch back to the home activity directory screen or to the settings screen, respectively. In the example, the History button 2220 is disabled because the corresponding activity history screen 2200 is the presently-displayed view.

### Mobile User Activity Activity Jeweling Effect and Indicators

Mobile user activities displayed within the home activity directory screen can be categorized chronologically by their start times and end times, for example. Jewels or other icons can be displayed in association with each displayed activity and indicate the corresponding activity's status. The following is a list of indicators that can be communicated using the displayed jewels:

An On Going or Active Timed indicator can be displayed in connection with an activity that lasts over the course of several calandar dates and can be represented by a green or yellow circle encompassing two arcs immediately above a radial line, for example.

An Active Open Ended indicator can be displayed in connection with an activity of an ongoing or recurring nature and can be represented by a green circle containing a circular arrow oriented in a clockwise rotation, for example.

A Scheduled Activity indicator can be displayed in connection with an activity that is scheduled for future attention or consideration and can be represented by a gray circle enclosing a thick, strirated straight arrow oriented in a horizontal manner from left to right, for example.

A Finished indicator can be displayed in connection with an activity having an end date that is in the past and can be represented by a yellow circle containing red radial lines extending from its center and stylized like the face of a clock, for example.

An Incomplete Information or Interrupted indicator can be displayed in connection with an activity that is partially entered or an activity with incomplete identifying information and can be represented by a yellow or orange circle encompassing a horizontal line that is broken on an oblique rising angle between two nodes, for example.

An Activities in Conflict indicator can be displayed in connection with an activity that has associated information stored on the mobile device that is presently in conflict with the corresponding information resident in the DBITS component and can be represented by a yellow circle containing a red equilateral triangle having an exclamation mark in its center, for example. Once a conflict has been resolved, the Activities in Conflict indicator can revert back to whatever indicator was previously displayed.

### Mobile User Activity Information Management System Synchronization Feature

In certain embodiments, the system can require that a user's mobile device attempt to synchronize itself with the DBITS component each time the mobile device is turned on. During the first initialization of the mobile device, the system can launch a registration process and thereafter pull down all of the pertinent data for each session from the DBITS component. For example, the system can automatically synchronize and compare the information contained in the data fields of the mobile device with the corresponding information contained in the data fields of the DBITS. This synchronization process can advantageously enable the user to input mobile user activity information directly into a back-end component and have the data available to the user on the mobile device.

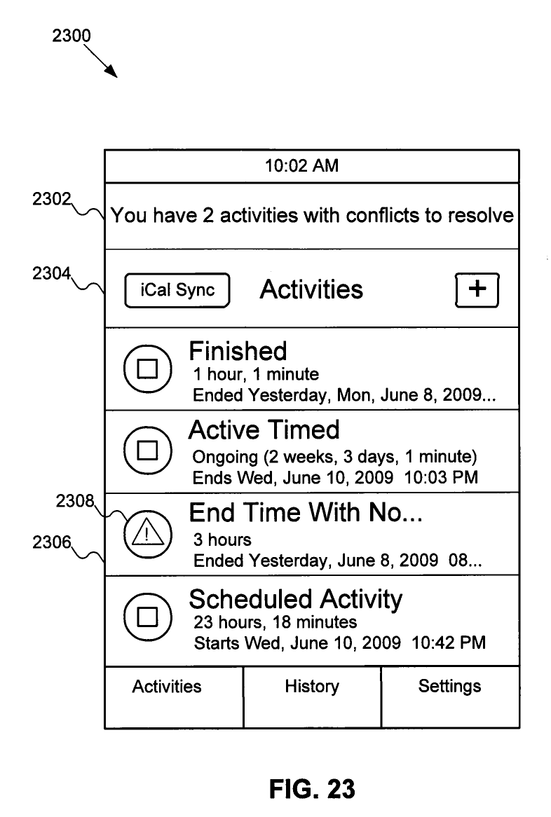

FIG. 23 is a first example of a mobile user activity information management system synchronization resolution screen 2300. The synchronization resolution screen 2300 has a banner section 2302 displayed above an activities section 2304 and can include a notification of any conflicts to resolve. In certain embodiments, the activities section 2304 displays only mobile user activities having a synchronization issue. Alternatively, the activities section 2304 can display all of the mobile user activities that would be displayed in the home activity directory screen, for example, but provide a visual indication for each mobile user activity that presently has a synchronization issue.

In the example, the synchronization resolution screen 2300 indicates that a certain displayed activity 2306 is currently experiencing a synchronization issue by displaying a red triangle within a yellow circle in the jewel 2308 that corresponds to the particular activity 2306. Additionally, the banner section 2302 can specify synchronization issue-related information such as how many activities are currently experiencing synchronization issues.

### Activities in Conflict During Synchronization

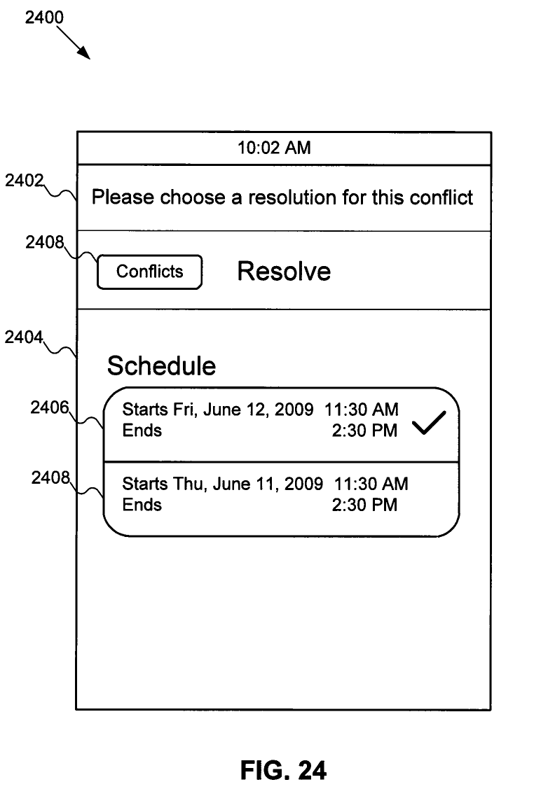

If the data stored in the mobile device is not identical to the corresponding information stored within the DBITS component, for example, the system can create a condition called a conflict. Should a conflict arise during the synchronization process, the system can seek to resolve the conflict by bringing it to the mobile user's attention. The system can then require that the conflict be resolved by the mobile user at the mobile application interface. For example, the mobile device can display a mobile user activity information management system synchronization conflict resolution screen. FIG. 24 is a second example of a synchronization conflict resolution screen 2400.

A header section 2402 of the synchronization conflict resolution screen 2400 indicates that there is a synchronization conflict for a particular activity. A conflict detail area 2404 of the synchronization conflict resolution screen 2400 displays the particular activity that has a synchronization conflict. The conflict detail area 2404 displays the discrepancies for the data in question. In the example, an activity schedule item is out of sync between the mobile device and the DBITS component.

In certain embodiments, the system can request that the mobile user select which data to use. Alternatively, the system can be set to automatically resolve conflicts. For example, the system can be set to automatically defer to data stored at the mobile device. Additionally, certain embodiments can require that each conflict be resolved independently of other conflicts and other embodiments can enable the system itself or the mobile user to resolve multiple conflicts at the same time.

In the example, a first data listing 2406 displays the pertinent data that is currently stored at the mobile device and a second data listing 2408 displays the pertinent data this is currently stored at the DBITS component. Icons (not shown) can be used in connection with the data listings 2406 and 2408 to indicate which data is from the mobile device and which data is from the DBITS component. Here, the mobile user has selected the data from the mobile device, as indicated by a check mark in the first data listing 2406. In certain embodiments, the system can immediately populate both of the data listings 2406 and 2408 with the data from the selected data listing. Once the mobile user has selected a data set, the system can save the change(s) to the activity at both the user's mobile device and the DBITS component.

### Alerts & Service Unavailability

The mobile application, the DBITS component, and the web-accessed database interface can each encounter any number of circumstances, such as service interruptions or hardware failure, that can serve to prevent the component from performing as designed. In situations where the system attempts to perform a processing task or other related task but is unable to successfully complete the task, the system can use a number of different alert mechanisms to advise the mobile user of the current status of the system or component and what, if anything, the mobile user can do to remedy any concerns.

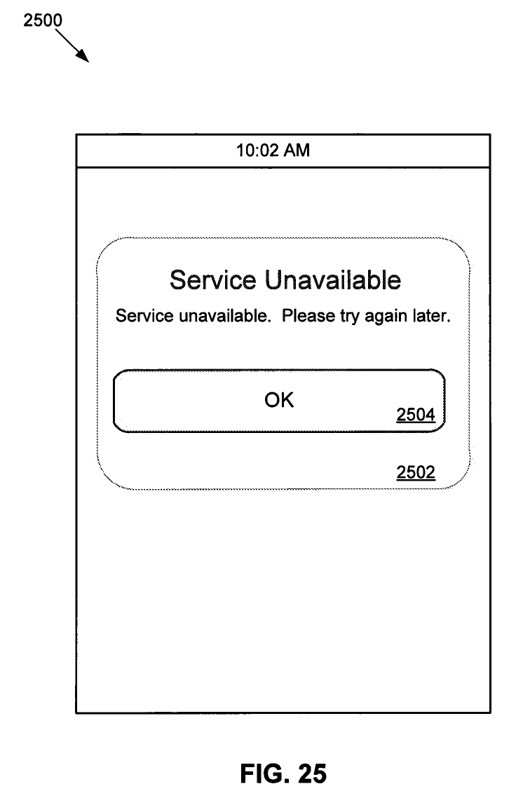

In situations involving a loss of network connectivity, the system can provide the mobile user with a “Service Unavailable” alert screen such as the mobile user activity information management system alert screen 2500 illustrated in FIG. 25. In the example, a “Service Unavailable” sub-screen 2502 includes an OK button 2504. The “Service Unavailable” sub-screen 2502 can advise the user as to what, if anything, the user can do to address the issue. Here, the advice to the mobile user is to try again later. Once the mobile user has read the information by the “Service Unavailable” sub-screen 2502, the mobile user can press the OK button 2504 to close the “Service Unavailable” sub-screen 2502.

In certain embodiments, the mobile user can adjust system settings so that the mobile user can either work offline or on the mobile user's carrier network. Thus, the mobile user can advantageously move in and out of the carrier network without needing to stop entering information via the mobile device. Each time the mobile application synchronizes itself with the DBITS component, the mobile user can address any conflicts of data between the DBITS component and data captured by the user's mobile device.

### Mobile User Activity Information Management System Support Information Screen

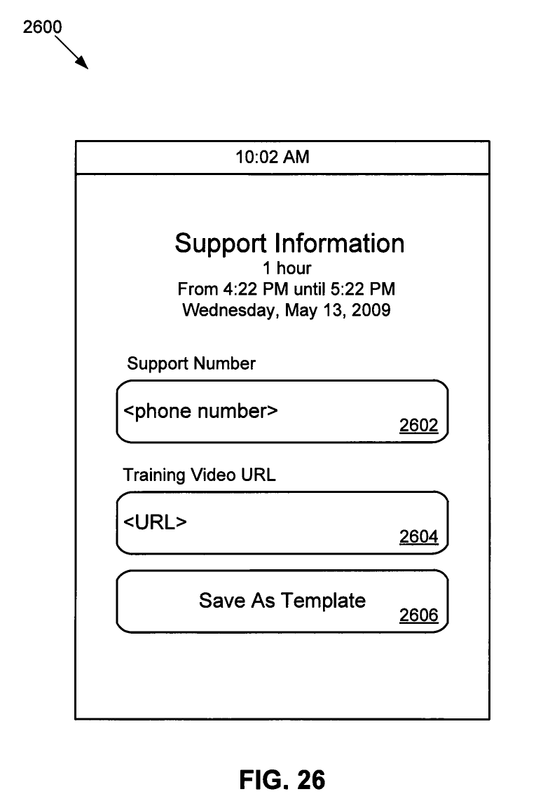

FIG. 26 is an example of a mobile user activity information management system support information screen 2600. In the example, a Support Number data field 2602 provides the user with a phone number that the user can call for technical support. A Training Video data field 2604 provides a URL for a website at which the user can view a training video. The support information screen 2600 can also provide a Save As Template button 2606 to enable the mobile user to save the displayed data field layout, for example, as a template for future use.

### User-Programmable Business Rules

The disclosed technology can advantageously enable a user to define within the mobile application a number of specific conditions to require the mobile application to perform a certain defined task or function. The system can allow the mobile user to create relationships between the different data fields and utilize the output associated from those relationships to assist in the performance of specific tasks, for example. The system can allow the mobile user to create such relationships both on the mobile platform and on the web-based back-end application.

### DBITS Component & Web-Based Interface

The DBITS component can be advantageously structured to change to the user-defined standards and dimensions. Thus, the database portion of the DBITS component can be held to the same size as the data that the mobile user wishes to store. This arrangement can provide efficient and fast processing of mobile user activity information.

Embodiments of the disclosed technology can include a web-based interface for the data that can advantageously display the data contents of each mobile user activity and dynamically manage the associated data.

General Description of a Suitable Machine in which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like. As used herein, handheld devices can include mobile devices such as mobile phones.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an implementation of the disclosed technology” or the like are used herein, these phrases are meant to generally reference embodiment possibilities and are not intended to limit the invention to particular configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A machine-controlled method, comprising:
a mobile electronic device presenting to a mobile user a graphical user interface (GUI) that allows the mobile user to enter mobile user activity information corresponding to a particular mobile user activity;
the mobile electronic device receiving the mobile user activity information from the mobile user through the GUI;
the mobile electronic device creating a correlation between the mobile user activity information and the particular mobile user activity; and
the mobile electronic device transmitting to a remote database system the mobile user activity information and the correlation between the mobile user activity information and the particular mobile user activity.

2. The machine-controlled method of claim 1, wherein the mobile electronic device comprises an Internet-enabled phone.

3. The machine-controlled method of claim 1, further comprising:
the mobile electronic device receiving from the mobile user through the GUI an add attachment directive;
the mobile electronic device creating an association between the mobile user activity attachment and at least one attachment identified by the mobile user; and
the mobile electronic device transmitting to the remote database system the attachment and the association between the mobile user activity attachment and the mobile user activity information.

4. The machine-controlled method of claim 3, wherein the attachment comprises at least one of an image file, a document, an audio file, and an email message.

5. The machine-controlled method of claim 1, further comprising the mobile electronic device querying the remote database system to determine whether the remote database system has an existing database entry corresponding to the particular mobile user activity.

6. The machine-controlled method of claim 5, wherein, responsive to the mobile electronic device determining that the remote database system has an existing database entry corresponding to the particular mobile user activity, transmitting to the remote database system the correlation between the mobile user activity information and the particular mobile user activity comprises transmitting to the remote database system a database entry identifier identifying the existing database entry corresponding to the particular mobile user activity.

7. The machine-controlled method of claim 5, further comprising, responsive to the mobile electronic device determining that the remote database system does not have an existing database entry corresponding to the particular mobile user activity, transmitting to the remote database system a request for creation of a new database entry within the remote database system, the new database entry corresponding to the particular mobile user activity.

8. The machine-controlled method of claim 1, wherein the particular mobile user activity comprises one of a meeting, a phone call, and a business event.

9. The machine-controlled method of claim 1, further comprising the mobile electronic device receiving from the remote database system an alert.

10. The machine-controlled method of claim 1, further comprising the mobile electronic device transmitting to the remote database system at least one of a timestamp, a mobile user identifier, and a geographic location identifier.

11. The machine-controlled method of claim 1, wherein the mobile electronic device comprises an Apple iphone.

12. The machine-controlled method of claim 1, further comprising the mobile electronic device storing the mobile user activity information and the correlation between the mobile user activity information and the particular mobile user activity.

13. The machine-controlled method of claim 1, further comprising the mobile electronic device editing the mobile user activity information responsive to a directive from the mobile user.

14. An apparatus, comprising:
a mobile user activity information receiving module operable to receive from a mobile user via a graphical user interface (GUI) mobile user activity information corresponding to a particular mobile user activity;
a mobile user activity information correlation module operable to create an association between the received mobile user activity information and the particular mobile user activity;
a mobile user activity information local storage module operable to store the mobile user activity information and the association between the mobile user activity information and the particular mobile user activity; and
a mobile user activity information transmission module operable to transmit the mobile user activity information and the correlation between the mobile user activity information and the particular mobile user activity to a remote database system.

15. The system of claim 14, wherein at least the mobile user activity information receiving module is implemented within a mobile electronic device.

16. The system of claim 15, wherein the mobile electronic device comprises an Apple iphone.

17. The system of claim 14, further comprising an activity edit module operable to allow the mobile user to edit the stored mobile user activity information.

18. The system of claim 14, further comprising an add attachment module operable to allow the mobile user to add at least one attachment to the stored mobile user activity information.

19. The system of claim 14, further comprising an add contact module operable to allow the mobile user to add at least one contact to the stored mobile user activity information.

20. The system of claim 14, further comprising a synchronization module operable to synchronize the mobile user activity information with corresponding mobile user activity information stored at the remote database system.
